(19) United States
(12) Patent Application Publication
(10) Pub. No.: US 2016/0378102 A1
(43) Pub. Date: Dec. 29, 2016

(54) REMOTELY DEPLOYABLE INVERSE PROACTIVE STATUS MONITORING AND REPORTING SYSTEM AND METHOD OF USE

(71) Applicant: Greg Goodrich, Southlake, TX (US)

(72) Inventor: Greg Goodrich, Southlake, TX (US)

(21) Appl. No.: 15/188,658

(22) Filed: Jun. 21, 2016

Related U.S. Application Data
(60) Provisional application No. 62/183,430, filed on Jun. 23, 2015.

(51) Int. Cl. G05B 19/4155; G05B 19/406; H04L 29/08

(52) U.S. Cl. CPC G05B 19/4155; H04L 67/125; G05B 19/406; G05B 2219/31396

(57) ABSTRACT

A method for assembling, integrating and utilizing common network elements including routers, modems, computers and software routines for maintaining and manipulating operating functions of remotely deployable controller systems, sensors, values, relays and other electro-mechanical devices to function as an inverse proactive status monitor and management system with reporting and remote access functions in a multi-tenant operating environment.

### CROSS-REFERENCE TO RELATED APPLICATION

### 35 USC §119(e)

Priority is claimed from U.S. provisional application for patent 62/183,430, filed on Jun. 23, 2015, which is hereby incorporated by reference. This application may be related to the present application, or may have some drawings and/or disclosure in common.

### FIELD OF INVENTION

The present invention relates generally to remote monitoring systems.

### BACKGROUND OF INVENTION

Monitoring, control and management systems are capable of monitoring and interactively controlling a wide variety of different devices or device integrated systems. These systems typically receive or detect events (either timed, random or exception based) sent over wired and/or wireless networks from monitoring devices, sensors or systems including manual systems operated by humans. There are a great number of monitoring devices that can monitor virtually anything (e.g. temperature, pressure, electrical voltages and currents, humidity, flow volume, data volume, etc.). The events generated by these devices are typically sent via a gateway/relay to the monitoring control system (which can reside locally or, more commonly, remotely over the internet) where they are logged in some sort of database or system server. These events can then be reported on and analyzed. The objective is to make sure the equipment or system(s) the devices are monitored and working optimally on a continuous basis. In cases where systems fail, corrective action is initiated.

The problem is that these monitoring devices occasionally lose “sync” with their gateway/relay or the gateway locks up, has some kind of error condition preventing normal operation or stops communicating with the monitoring system altogether. The internet connectivity device(s) may also error out or drop the circuit. Any number of conditions may cause normal communications to cease.

The gateways/relays in these systems typically only forward these events and have no ability to store the data until the error condition is corrected. So once an event is lost it is lost. Additionally, the monitoring systems typically do not monitor themselves to confirm they are receiving data from the devices, they just simply don't log anything when a fault occurs. This causes inaccurate statistics and momentary non-reporting of equipment or system health which can result is serious complications.

One limitation of the prior art is the difficulty in determining the source and location of each error condition. For example, an error condition could result if the internet is down, the modem or communication device has an error condition, the gateway has some type of error condition, the devices themselves cannot communicate with the gateway/relay or the actual systems being monitored by the devices have a problem. Often there is no way to recover from these unknown error conditions without sending someone on-site to assess the situation. This causes time delays resuming normal operations, can cause companies to miss contractual monitoring obligations, and often results unnecessary expense. In cases where the monitoring devices are far from the home office (i.e. in another state or country) the cost and time required to send someone to the site can be an expensive option.

Further, these monitoring devices, and their gateway(s) or relay(s), are often located in remote areas or plants that are not connected to any external network. Implementing the system illustrated by the present embodiment and incorporating data circuits (traditional, wireline or wireless) which can be utilized to send events over the internet to the monitoring system located virtually anywhere remedies this problem.

Although great strides have been made in the area to monitor remote devices and systems, many shortcomings remain.

Although there are several apparatuses which may have various functions related to the remotely deployable inverse proactive status monitoring and reporting system, none of these either separately or in combination with each other, teach or anticipate the current invention. Therefore, there remains an unmet need in the field of remote monitoring systems. The current invention will fulfill this unmet need.

### SUMMARY OF INVENTION

The following presents a simplified summary in order to provide a basic understanding of some aspects of the disclosed invention. This summary is not an extensive overview, and it is not intended to identify key/critical elements or to delineate the scope thereof. Its sole purpose is to present some concepts in a simplified form as a prelude to the more detailed description that is presented later.

The invention described herein automates several key aspects of the traditional remote monitoring system. The first fundamental departure from traditional remote monitoring systems, the autonomy function, designed into the present embodiment is the point of reference defined within the monitoring system. Here, the on-site system is defined as the controller system; which, when all other means of interconnectivity with remote controllers or monitoring stations is impaired or interrupted, has programed routines to detect network connectivity or loss thereof; detect connectivity locally with the devices being monitored; apply recovery actions to reset, reboot, restart or reinitialize sub-systems within the system or interconnect network being monitored and/or controlled; or, isolate sub-systems when appropriate by blocking, locking, suspending or otherwise disengaging interconnectivity of the sub-system and the system; and when appropriate, activating power disconnect and restoration controls to force a hard reboot or power-down function to protect devices, sub-systems and systems from damage or harmful operating conditions.

The second fundamental departure from traditional remote monitoring systems designed into the present embodiment, the observation perspective, is the functional direction of control. In the present embodiment, the on-site system can be viewed as the on-site control node reporting status of the local systems to the remote controller node. If the on-site controller detects loss of interconnectivity or interoperability with the remote controllers, the on-site controller is programmed to automatically initiate steps to recover interconnectivity and interoperability with the remote controllers. Additionally, during the interval where interconnectivity is impaired, the on-site controller can either allow the local systems to operate normally, or if necessary, begin a safety shut down procedure to protect the systems and local environment until such time that intervention occurs.

The third fundamental departure from traditional remote monitoring systems designed into the present embodiment, multi-tenancy, is the integration of multi-tenant distributed computing designed into the remote controller array. In the present embodiment, the remote controller array is a multi-point network of shared and hosted computer processing environments, represented by physical computers, virtual servers and database storage devices implemented to provide greater accessibility to on-site controllers from multiple locations with access authorization and authentication credentials. Network reliability using the multi-tenant distributed architecture provides diversity in network topology to make the entire interconnect network more resistant to outage and more resilient to interrupts which may occur. The key concept is to provide the means and where with all within the on-site local controller to access any number of suitable remote controllers to recover and maintain continuous, uninterrupted interconnect with the remote controllers.

The forth departure from traditional remote monitoring systems designed into the present embodiment, situational awareness, is the functional integration of local sensors which can be integrated in series with local devices which otherwise have no linking or other features used to remotely monitor operations of such devices, nor have features which allow for blocking, locking, suspending or otherwise disengaging interconnectivity of the sub-system and the system; and when appropriate, incorporating relays for activating power disconnect and restoration controls to force a hard reboot or power-down function to protect devices, sub-systems and systems from damage or harmful operating conditions. The present embodiment not only provides for the introduction of such externally integrated devices to the non-equipped devices, it also provides the on-site controller the means to manage these devices according to routines programmed into the on-site controller.

There are several methods currently used today for remote monitoring systems. The present embodiment can co-exist with such systems and does not alter or disable this functionality.

The present embodiment comprises routers, modems, electrical power control devices with control interfaces, wireless communication devices, LAN/WAN communication devices, computer systems equipped with memory, environmental sensors, relays, on-site operating software equipped with executable on-demand and automatic routines and, remote operating software equipped with executable on-demand and automatic routines. Additionally, man-machine interfaces are provided for human intervention when appropriate.

Other “remote” systems have a NOC that polls probes or on-site systems and when something needs attention, the centralized staff intervenes. If critical situations develop, service technicians are dispatched to restore the system. If something shows up on the monitoring screen as needing attention, a technician can login and manually restart devices or login and make changes to try and resolve any issue; but only if sensors and relays are incorporated and remotely accessible to the NOC technician. Otherwise, a technician must be dispatched to the location.

In the present embodiment, integrated routines that will go into automatic recovery mode if the on-site controller loses contact with the remote controllers and if a sensor reports that intervention is necessary. It is this feature that is named the “inverse” aspect of the present embodiment. By inverting the direction of control as compared to traditional systems, routines get initiated and execute tasks such as resetting a modem if the internet cannot be reached, to try and reestablish a stable connection. If all else fails, the on-site controller can activate a web enabled power switch to perform a power cycle routine. Alternatively, the router can automatically switch circuits if there is a problem with the primary one. Such on-site devices utilized in the present embodiment are called “outbound” probes. The controller system's monitoring software is the “inbound” portion of the probe process, probing all of the device application ports being utilized by the system and any client devices within the network that require active monitoring.

Essentially the on-site controller constantly supervises what activities should be happening and as long as the system is properly functioning the on-site controller is reporting that all is well; however, if the reporting links to the remote controllers go dark and the local environment starts having problems, the on-site system can reboot and recover without having someone from the central center do anything. The on-site devices do know what systems should be functional and continuously probe to make sure all of the connectivity is up and working; and, when necessary, resets systems and sub-systems as necessary including switching to secondary circuits. The primary function of the on-site system is to provide for continuous and even autonomous observation of the local environment and to maintain uninterrupted connectivity to the remote controllers. Under normal operations, the on-site controller only collects data/stats and notifies the “NOC” to initiate corrective actions if the automated routines fail to correct the issue. Technicians can then login and actually power cycle any connected device manually (not just the monitored circuits) or further troubleshoot any issues.

Still other objects of the present invention will become readily apparent to those skilled in this art from the following description wherein there is shown and described the embodiments of this invention, simply by way of illustration of the best modes suited to carry out the invention. As it will be realized, the invention is capable of other different embodiments and its several details are capable of modifications in various obvious aspects all without departing from the scope of the invention. Accordingly, the drawing and descriptions will be regarded as illustrative in nature and not as restrictive.

### BRIEF DESCRIPTION OF THE DRAWINGS

Various exemplary embodiments of this invention will be described in detail, wherein like reference numerals refer to identical or similar components, with reference to the following figures, wherein:

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a simplified schematic of a system and method of use in accordance with a preferred embodiment of the present application; and

FIG. 2 is a schematic of the system illustrated as a multi-tenant configuration.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION

The claimed subject matter is now described with reference to the drawings. In the following description, for purposes of explanation, numerous specific details are set forth in order to provide a thorough understanding of the claimed subject matter. It may be evident; however, that the claimed subject matter may be practiced with or without any combination of these specific details, without departing from the spirit and scope of this invention and the claims.

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be routine undertaking for those of ordinary skill in the art having the benefit of this disclosure.

The system and method of use in accordance with the present application overcomes one or more of the above-discussed problems commonly associated with conventional monitoring devices and systems. Specifically, the system and method of the present application provides rapid and effective means to inform third parties of situations discussed above. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

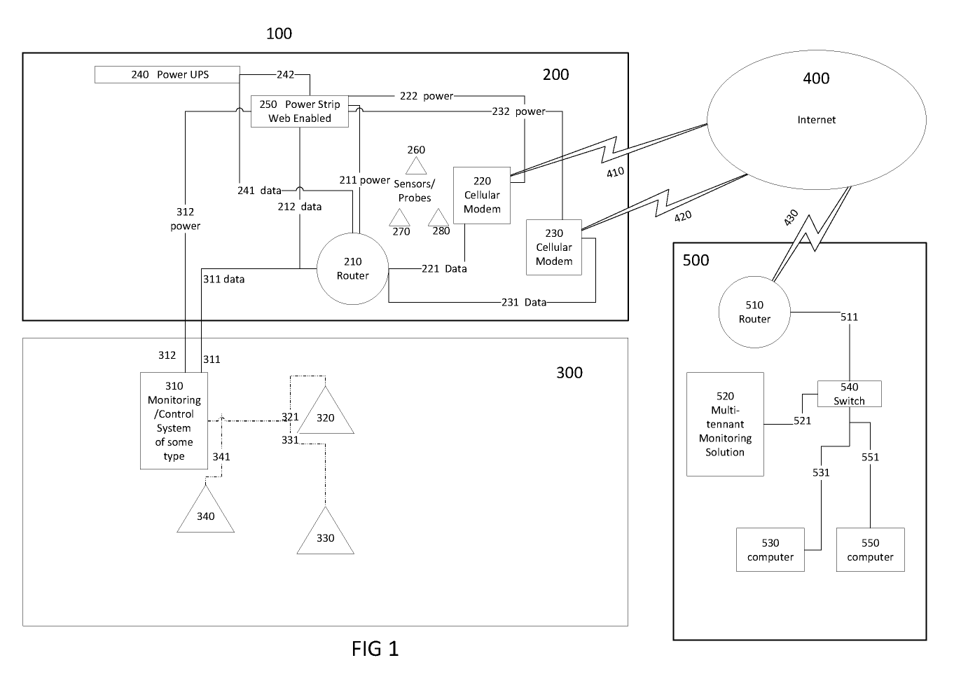

Referring now to the drawings wherein like reference characters identify corresponding or similar elements throughout the several views, FIG. 1 depicts simplified view of a system 100 and method of use in accordance with a preferred embodiment of the present application. It will be appreciated that system 100 overcomes one of more of the above-listed problems commonly associated with the conventional monitoring systems.

The present embodiment is illustrated in FIG. 1 as a system 100 being deployed in a single site configuration with networking 400 to a single remote NOC 500. The system 100 represents the remote NOC 500 containing the remote controller 520, remote router 510, remote computer 530, remote switch 540 and the remote monitor 550. Local data connections within the remote NOC are represented by circuits 511, 521, 531 and 551, which combine at the remote switch 540.

As shown in FIG. 1, the remote NOC is interconnected to the on-site location 300 via the networking 400. Interconnect 430 is a broadband interconnection from the remote NOC to the networking 400 environment consisting of the internet and cloud based solutions. Interconnects 410 and 420 represent diversity and redundancy of networking 400 between the remote NOC and the on-site controller system 200 and operating system 300.

As shown in FIG. 1, the on-site controller system 200 is illustrated with redundant wireless networking devices 220 and 230. These devices 220 and 230 illustrate diverse carrier cellular modems. Interconnection is made between the devices 220 and 230 and the on-site router 210 using data connections 221 and 231, respectively. Power connections to devices 220 and 230 are made using connections 222 and 232 to the web enabled power strip 250.

The on-site router 210 has data connection 212 to the web enabled power strip 250 in addition to its power connection 211. The web enabled power strip 250 is connected and supported by a uninterruptable power supply 240 which has data connect 242 to the on-site router 210, and power connection 241 to the web enabled power strip 250.

Additional power and data connections to the on-site router 210 are illustrated as power connection 312 and data connection 311 to the on-site controller system 310.

FIG. 1 also illustrates the on-site electro-mechanical system 300 to be controlled and monitored by systems 200 and 500. System 300 is shown to have the on-site controller system 310 with power connection 312 to the web enabled power strip 250. Additionally, data connection 311 is shown connecting the on-site controller system 310 to the on-site router 210 using data connection 311.

The local environment shown represents multiple electro-mechanical sub-system devices 320, 330, and 340. Sensors and probes are illustrated as 260, 270 and 280. Sub-system devices 320 are connected to the on-site controller system using connection 321. Subsystems 330 and 340 are connected to the on-site controller system using connection 331 and 341, respectively.

Using current power and routing technologies this system 100 addresses the error conditions above and gives insight into these monitoring systems so remote technicians can troubleshoot error conditions and correct those that are not automatically resolved.

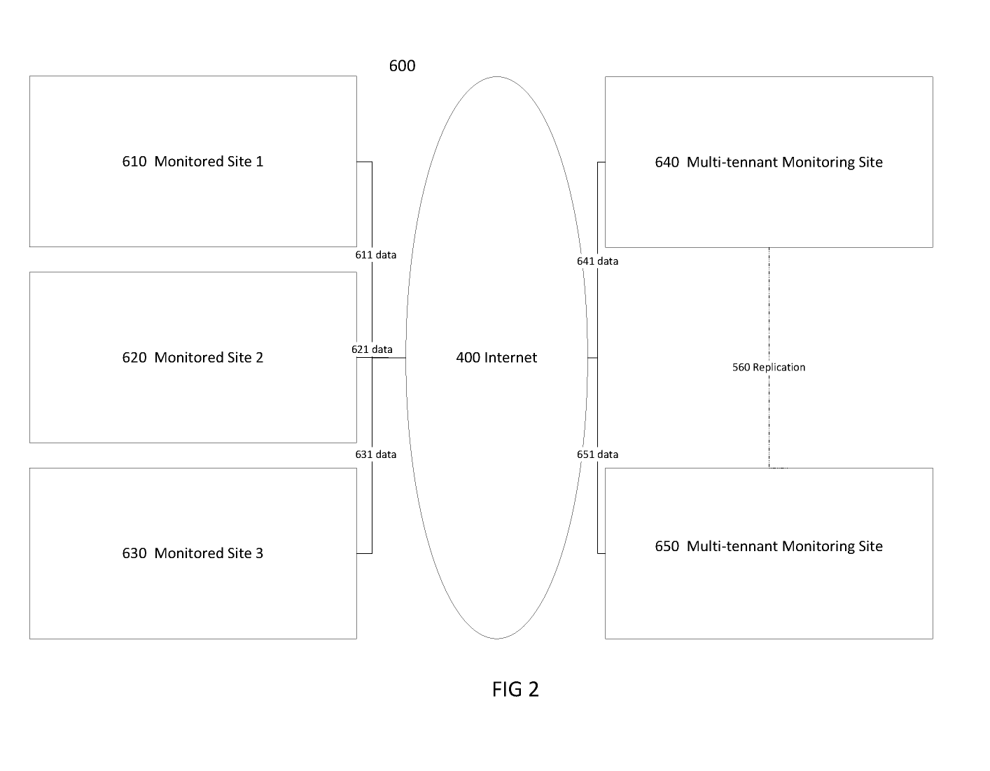

The system utilizes a smart power switch 250 that monitors internet connections and automatically reboots modems 220 and 230 if they aren't connected. This also gives the ability for technicians to login and power cycle any device 320, 330 or 340 (such as the gateway) connected to the power switch 250 to get it to resume normal operations. The features of system 100 are shown in FIGS. 1 and 2, wherein the system communicates with a computer 530, cloud service 400, an on-site controller 310; and a remote controller 520; all being configured to monitor and restart controlled system 300 without the need for a third party to be onsite. Accordingly, the system 100 allows offsite monitoring and management of the control systems 200 and 300 during use.

It will be appreciated that the routing technology will automatically switch to the backup data circuit 420 if the primary circuit 410 drops for any reason. The monitoring server 310 makes connections to each device 320, 330 and 340 in the system 300 to see that it is working properly and can also make connections to the gateway/relay devices 320, 330, or 340 to make sure they are working optimally. All of this is presented on a computer monitor 550 providing red light green light operational status at a glance.

FIG. 2 illustrate how the present embodiment can be deployed in a multi-tenant configuration. As shown, the networking 400 between a plurality of monitored sites 610, 620, 630 and the remote control systems 640 and 650, which is provided for using links 611, 621, 631, 641 and 651 as data connections. Data link 560 is also shown as the redundant data link between the diverse remote controller systems 640 and 650.

As shown, the resilience of the present embodiment is shown wherein each of the on-site controller systems located at separated and diverse locations, 610, 620 and 630 can interact with and be controlled and monitored by either or both remote controller systems 640 and/or 650.

The particular embodiments disclosed above are illustrative only, as the embodiments may be modified and practiced in different but equivalent manners apparent to those skilled in the art having the benefit of the teachings herein.

It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

It may be advantageous to set forth definitions of certain words and phrases used in this patent document. The term “couple” and its derivatives refer to any direct or indirect communication between two or more elements, whether or not those elements are in physical contact with one another. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

What has been described above includes examples of the claimed subject matter. It is, of course, not possible to describe every conceivable combination of components or methodologies for purposes of describing the claimed subject matter, but one of ordinary skill in the art can recognize that many further combinations and permutations of such matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

We claim:

1. A method for assembling, integrating and operating a remotely deployable inverse proactive monitoring and management system comprising:
On-site controller system;
Remote controller systems;
Routers;
Modems;
Electrical power control devices with control interfaces;
Uninterrupted Power Supply with control interface;
Wireless communication devices;
LAN/WAN communication devices;
Computer systems;
Memory;
Plurality of environmental sensors;
Plurality of relays;
On-site operating software equipped with executable on-demand and automatic routines; and,
Remote operating software equipped with executable on-demand and automatic routines.

2. The remotely deployable inverse proactive monitoring and management system in claim 1 further comprising:
the on-site controller system with processors, memory, electronic data communication capabilities, networking capabilities, a plurality of environmental sensor input and output interfaces with action capabilities programmed into the on-site operating software equipped with executable on-demand and automatic routines; and,
a plurality of the remote controller systems with processors, memory, electronic data communication capabilities, networking capabilities and the remote operating software equipped with executable on-demand and automatic routines configured to support and operate interactively with the on-site controller system and further configured to operate within a multi-tenant environment to send data to and receive data generated and transmitted from the on-site operating software equipped with executable on-demand and automatic routines;

3. A method in accordance with claim 1 further comprising: electro-mechanical devices to be monitored and managed; redundant and diverse interconnectivity for communications between the on-site controller system and the plurality of the remote controller systems; and, probe functionality with remote visualization of operating conditions electro-mechanical devices which are not equipped with remote telemetry functions to provide monitoring and management of such devices.

4. A method in accordance with claim 1 wherein the plurality of environmental sensors, the plurality of relays and the electrical power control devices with control interfaces are integrated to the remotely deployable inverse proactive monitoring and management system through ports and terminals of the routers and the modems to provide status inputs from the plurality of environmental sensors and plurality of relays connected to the electro-mechanical devices to be monitored and managed.

5. A method in accordance with claim 1 to supervise the health-status of the electro-mechanical devices to be monitored and managed and respond to commands received by the on-site controller system from the remote controller systems to execute on-demand routines; and to execute the automatic routines in accordance with criteria programmed into the on-site operating software equipped with executable on-demand and automatic routines and programmed into the remote operating software equipped with executable on-demand and automatic routines.

6. A method and use in accordance with claim 1 to detect and execute a component or system reset and recovery routines as necessary comprising a web enabled power switch interconnected to the on-site controller system.

7. A method and use in accordance with claim 1 comprising series relays and sensors to function as an intermediary bridge to the electro-mechanical devices which are not equipped with remote telemetry functions, to provide monitoring and management of such electro-mechanical devices, to the on-site controller system.

8. A method in accordance with claim 2 further comprising: viewing and displaying data generated by the and transmitted from the on-site operating software equipped with executable on-demand and automatic routines; and,
providing accessibility to the on-site controller systems through a plurality of the remote controller systems to execute on-demand and automated routines programmed within the on-site and remote operating software.
